(19) United States
(12) Patent Application Publication
(10) Pub. No.: US 2010/0037169 A1
(43) Pub. Date: Feb. 11, 2010

(54) DISPLAY OF SYSTEM OPERATING STATUS IN A MULTI-NODE SYSTEM

(75) Inventors: Nancy R. BEATY, Spencerport, NY (US); Damian R. COUCH, Webster, NY (US); Michael E. McCRACKAN, Pittsford, NY (US); William J. COLOSKY, Honeoye Falls, NY (US); Josephine H. SCHWABEL, Rochester, NY (US)

Correspondence Address: EASTMAN KODAK COMPANY;PATENT LEGAL STAFF, 343 STATE STREET, ROCHESTER, NY, 14650-2201, US

(73) Assignee: EASTMAN KODAK COMPANY, Rochester, NY (US)

(21) Appl. No.: 12/188,424

(22) Filed: Aug. 8, 2008

(51) Int. Cl. G06F 3/048

(52) U.S. Cl. 715/772

(57) ABSTRACT

A method for displaying operational status and health of a system, such as a multi-venue theater management system, by generating a perspective display mode image including system element images depicted and arranged according to a system configuration and generating and displaying a system status display including one or more displayable perspective images representing the operational status of the system by modifying the perspective model image for each perspective. A perspective is a visual representation of the system according to a relative significance of an aspect of the operational status of the system, such as system configuration, system operational status and user factors representing a display. The perspectives are depicted and arranged to represent a relative priority of visual display between the perspectives and relative priority of visual display between perspectives may be represented by at least one of relative size, color, relative location, and relative level of detail in depiction of the perspectives.

### FIELD OF THE INVENTION

The invention relates generally to a method and system for monitoring the operating health and status of a multi-node system, and in particular a multi-venue theater system, by displaying system node status information in a manner to represent one or more perspectives of system node status.

### BACKGROUND OF THE INVENTION

Distributed computer systems for the real time, integrated, concurrent monitoring, control and management of various processes and operations have become common. Typical applications include, for example, such diverse applications as systems for the execution of multi-point commercial transactions, the collection and display of information, the control of multi-stage or multi-path industrial processes and communications systems of various forms. Such systems are typically comprised of a plurality of process nodes that perform the operational tasks for which the system is intended and one or more centralized system management nodes connected to the process nodes through a network for monitoring and controlling the operations of the process nodes, typically under the supervision and control of a system operator.

A critical element in the control and management of such systems is the meaningful display to the system operator of information relevant to the operating status of the various process nodes so that the operator is made aware, in a timely manner, of changes in node operating status that require the operator's decision and possible intervention. This aspect of such systems, however, presents recurring problems because of the volume of information that typically must be monitored and displayed to the operator.

Systems of the prior art have attempted to address such problems by providing, for example, audible and visual alarms for particularly significant events, but have been generally unsuccessful for a number of reasons. One recurring problem, for example, is that many systems provide numerical indications of system health and status and operating condition, which is often necessary for the fine control of a system. It has long been known, however, that people more readily comprehend information presented in graphical rather than numerical form and often confuse one numeric readout for another when the readouts are similar in appearance. It is also well known that people often misread numeric values. Similar problems arise in systems wherein the arrangement and format of the readouts has been selected according to the aesthetics of the display rather than clarity in presenting the health and status data and the source of the health and status data, so that a user can readily be in error as to which element or process is represented by a given readout.

It should also be noted that even the provision of audible and visual alarms is often a source of error, particular in complex systems, because the user may often be overwhelmed by the number of alarms and alerts presented at any given time. It is very possible in such systems for critical problems or conditions to be effectively buried among a large number of lesser problems.

The present invention provides a solution to these and other related problems of the prior art by providing an improved method and system for presenting system operational health and status information to a system operator.

These and other objects, features, and advantages of the present invention will become apparent to those skilled in the art upon a reading of the following detailed description when taken in conjunction with the drawings wherein there is shown and described an illustrative embodiment of the invention.

### SUMMARY OF THE INVENTION

The present invention is directed to a method for displaying operational health and status of an information processing system, such as a multi-venue theater management system including process nodes for displaying image streams, that is, movies, videos and so on, a system management node for controlling the process nodes and a control and communication network.

The method includes generating a perspective display mode image including a plurality of processing node images, a system management node image and a network image that are depicted and arranged according to a system configuration. A system status display including one or more displayable perspective images representing the operational health and status of the system is generated by modifying a perspective model images representing the system for each perspective and displaying the resulting system status display.

As defined for purposes of the present invention, a perspective of an operational health and status of the system is a visual representation of the system according to a relative significance of at least one aspect of the operational health and status of the system. Aspects of the operational health and status of the system that can result in the generation of one or more perspectives in a system status display include changes in at least one of system configuration information, system operational health and status information and a user factor representing a display preference of a user of the system status display.

When the system status display image contains a plurality of perspectives, the perspectives are depicted and arranged to represent a relative priority of visual display between the perspectives. The relative priority of visual display between perspectives may be represented by at least one of relative size, color, relative location, and relative level of detail in depiction of the perspectives, such as a display of icons or symbols representing the component elements of a system or subsystem as opposed to a single icon or symbol representing the system or subsystem.

In a presently preferred embodiment of the invention, the perspective model is a sun and planet solar system model wherein a system management node image occupies a central sun position and each process node is represented by a process node image occupying a planet position around the sun position. Elements or aspects of or within a process node may in turn be displayed as further moons occupying moon positions around the planet position occupied by the process node, or as elements within a more highly detailed representation of the process node, and so on for as many iterations as necessary to display the required information. In addition, there may be two or more orbits around, for example, the system management sun or one or more of the process node planets. A network interconnecting the system management node and process nodes may, for example, have a hub and spoke configuration, and the flow of information or data through the network may be represented by pathway lines connecting the system management node image with each process node image, typically when there is an actual information or data flow between the system management node and a process node so that the pathways thereby represent paths of currently active information or data flow.

Each perspective is represented by at least one image object displayable in the system status display and system status display of the present invention may also comprise a control input to the system wherein one or more image objects of perspectives represented in the system status display include one or more an active image objects for control input to the system.

In addition, when the information processing system is a multi-venue theater management system each process node may include an image projection system including static or motion projection for displaying image streams from an image source and a process node controller responsive to the system manager node for monitoring and controlling the image projection system. The image source may be comprised of at least one of an image source located in the process node, an image source located in the system management node and a remote image source located externally to the system wherein the remote image source may be at least one of a satellite communication system for conveying digital image streams and a cable communication system. A process node does not have to include a projection system but may alternatively or additionally represent, monitor and control other specific functions as well, for example static displays of information and advertising also vendor operations including concessions, ticket sales etc.

More specifically, the present invention relates to a method for displaying operational status of an information processing system including a plurality of process nodes, a system management node for controlling the plurality of process nodes and a network interconnecting the process nodes and the system management node, comprising the steps of generating a perspective display mode image including a plurality of processing node images, a system management node image and a network image depicted and arranged according to a system configuration, generating a system status display image by modifying the perspective display model image to represent a perspective of the operational status of the system wherein a perspective of an operational status of the system is a visual representation of the system according to a relative significance of at least one aspect of the operational status of the system, and displaying the system status display image containing the perspective of the operational status of the system.

The present invention further relates to a system for displaying operational status of an information processing system including a plurality of process nodes, a system management node for controlling the plurality of process nodes and a network interconnecting the process nodes and the system management node, comprising a perspective display generator for generating a perspective display mode image including a plurality of processing node images, a system management node image and a network image depicted and arranged according to a system configuration, a status display generator for generating a system status display image by modifying the perspective display model image to represent a perspective of the operational status of the system wherein a perspective of an operational status of the system is a visual representation of the system according to a relative significance of at least one aspect of the operational status of the system, and a display system for displaying the system status display image containing the perspective of the operational status of the system.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a diagrammatic illustration of an exemplary multi-venue theater system;

FIG. 2 is a diagrammatic illustration of a process node of the theater system;

FIG. 3 is a diagrammatic illustration of a system management node of the theater system;

FIG. 4 is a diagrammatic illustration of a perspective representation of the theater system;

FIG. 5 is a representation of a perspective model;

FIGS. 6A-6G are diagrammatic illustrations of the display of perspectives representing changes in the operating status or system health of the system management system; and

FIG. 7 is a diagrammatic illustration of the display including a higher level galaxy perspective representing basic nodal information of systems at multiple venues.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

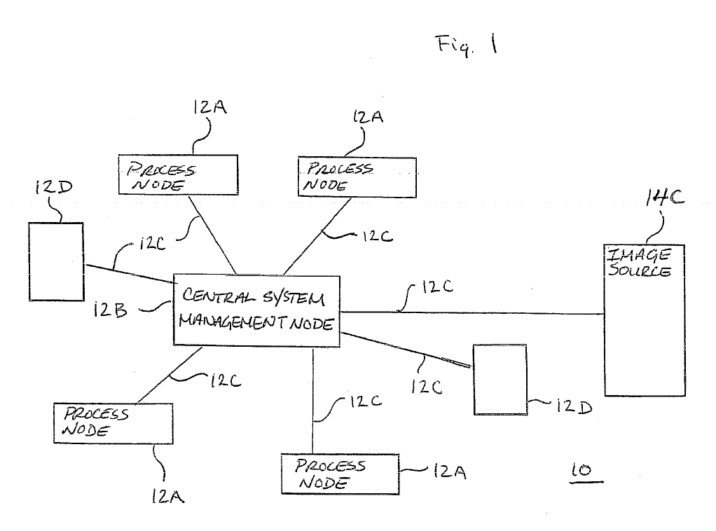

The following detailed description of the invention will describe an exemplary embodiment of the present invention for displaying the operational health and status of an information processing system implemented as a multi-venue theater management system 10 as illustrated in FIG. 1. As shown therein, system 10 includes a plurality of process nodes 12A and a central system management node 12B connected to process nodes 12A through a network 12C that may comprise for example, a hub and spoke network or any other suitable network topography. As indicated, and as discussed in further detail with regard to process nodes 12A and system management node 12B, the system 10 may further include one or more image source devices 14C, such as and for example, digital storage devices such as hard drives, optical disk devices or similar mass data storage devices or remote image sources such as connections to satellite or cable systems connecting system 10 to image data sources, such as digital film libraries or live transmission providers.

A system 10 will typically also include one or more display/control units 12D providing at least displays of the operational status and health of the system 10, such as in a system management office or facility or at a ticket or refreshment counter or as a lobby display. Certain of the display/control units 12D, such as those located in a system management office or ticket or refreshment stand may also include control input capabilities for controlling at least some aspects of the operations of the system 10. In this regard, a display/control unit 12D may include, for example, a visual display, and may include a control input such as a keyboard and/or mouse type device or may be comprised of a touch screen device providing display outputs or control inputs or both.

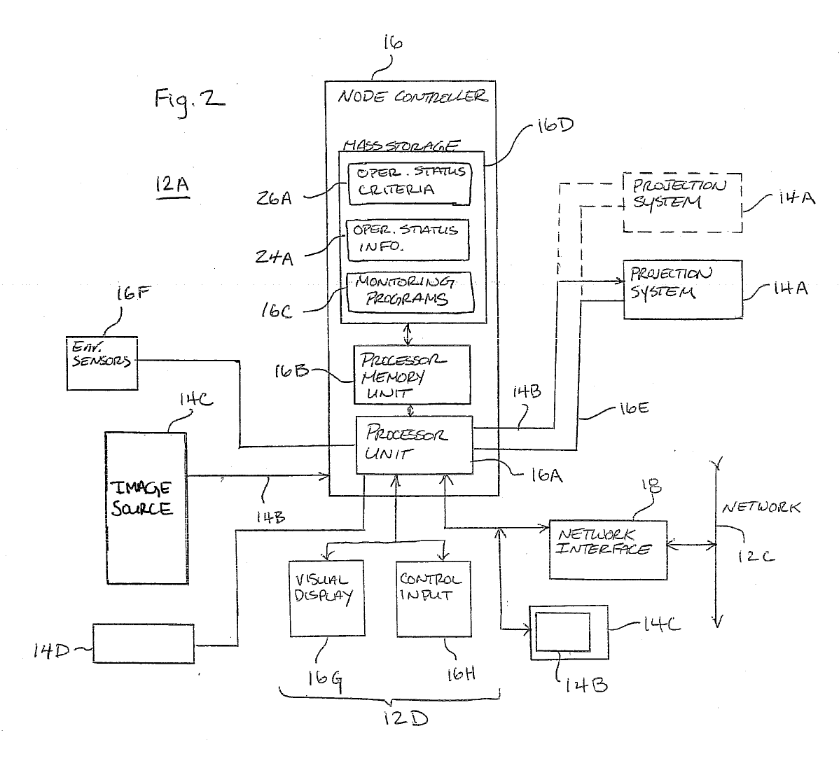

As shown in FIG. 2 each process node 12A includes one or more projection systems 14A which may be comprised of conventional film projectors or, more probably in future systems, digital projection systems displaying movies, trailers, advertisements and so on, received as digital image streams 14B received from digital image source devices 14C located in the individual process nodes 12A or alternatively centrally located in central management node 12B as seen in FIG. 1. It must be understood that the digital image streams may include, for example, image sequences, such as movies, videos, trailers and advertisements, still or single images, live feeds, and so on.

The following will assume that projection systems 14A are comprised of digital image projection systems receiving and displaying streams 14B of digital image data. For this purpose, image source devices 14C may include, for example, digital storage devices 14D, such as hard drives, optical disk devices or similar mass data storage devices, or remote image sources 14E, such as satellite or cable systems connecting system 10 to image data sources, such as digital film libraries or live transmission providers. It will be noted that locating or communicating image source devices 14C with central management node 12B as seen in FIG. 1 is advantageous as regards control and monitoring of image source devices 14C and the capability to share or multiplex at least some image source devices 14C among process nodes 12A. It should also be noted that if the system 10 centralizes image source devices 14C in central management node 12C, it is further advantageous to adopt a network 12C configuration that allows concurrent continuous data transmission of digital image streams between central management node 12B and each process node 12A, such as a hub and spoke configuration.

As illustrated in FIGS. 1, 2 and 3, each process node 12A typically includes a node controller 16 for controlling the operations of projector system 14A and a network interface 18 connecting node controller 16 and possibly projection system 14A to network 12C and controlling communications between node controller 16, projector system 14A and central system management node 12B. Each node controller 16 will in turn typically include a processor unit 16A with associated memory 16B executing projector system 12A and network interface 18 control and monitoring programs 16C stored in one or more mass storage devices 16D for controlling and monitoring. As will be discussed in further detail in the following, processor unit 16A and possibly network interface 18 will include monitoring connections 16E to projector system 14A to collect data regarding the operation and operational health and status of the associated projection system 14A. As also indicated generally in FIG. 2, a process node 12A may also include one or more environmental sensors 16F connected to node controller 16 or directly to network interface 18 for sensing and transmitting environmental parameters pertinent to the operation of the process node 12A, such as air temperature sensors, lighting sensors and fire, water and toxins sensors.

Lastly, process node 12A may include a display/control unit 12D, which may be comprised, for example, of a display unit 16G, such as a visual display, and/or a control input 16H, such as a keyboard and/or mouse type device, for providing local control inputs to the process node 12A and a local display of the status and operations of the process node 12A, or a touch screen device providing display outputs or control inputs or both.

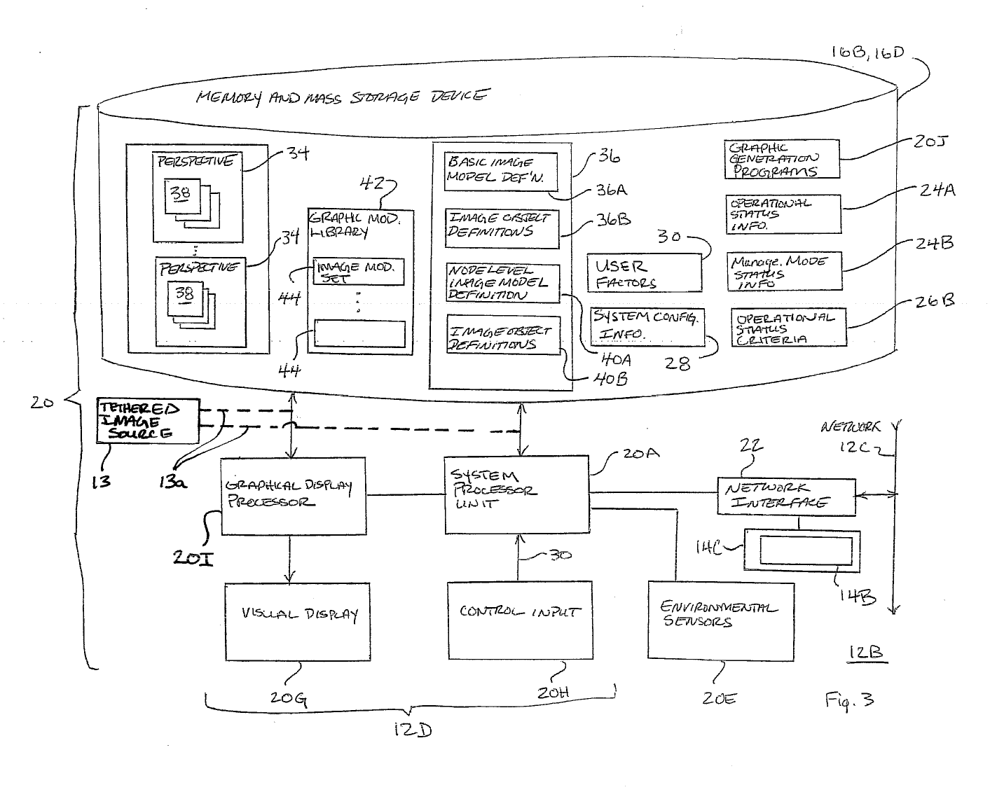

Turning to FIG. 3, central system management node 12B will typically include a system controller 20 for controlling the operations of management node 12B and a network interface 22 connecting system controller 20 to network 12C and controlling communications between system controller 20 and each of process nodes 12A. System controller 20, in turn, will typically include a system processor unit 20A with associated memory 16B executing system control programs 20C for controlling and monitoring system 10 and system management node 12B and stored in one or more mass storage devices 16D. Also included may be environmental sensors 20E, such as air temperature sensors, lighting sensors and fire, water and toxins sensors.

Lastly, system controller 20 may also include a display/control unit 12D that may be comprised, for example, of a display unit 20G, such as a visual display, and/or a control input 20H, such as a keyboard and/or mouse type device, connected to processor unit 20A for providing local control inputs to system management node 12B and a local display of the status and operations of system management node 12B and system 10, as discussed below, or a touch screen device providing display outputs or control inputs or both.

As described herein above, the present invention is directed to a method and system for monitoring and selectively displaying the operating health and status of a multi-node system, such as a multi-venue theater system 10, by displaying one or more perspectives of system health and status. For purposes of the present invention, a “perspective” of system status may be defined as a representation of system operational health and status arranged and presented according to the relative significance of one or more status factors and a given display of system status may include or be comprised of one or more perspectives. Status factors may in turn be defined as selected aspects of the system that are or should be of interest or significance to the display user, typically the system operator. Examples of status factors may include system configuration information, system operational status such as information about what's playing, how much time is remaining to play, what's cued up to play, if keys are present and enabled to allow playback etc. Status factors may also include user factors, that is, a display preference of a user of the system status display reflecting, for example, a user factor representing a display preference of a user of the system status display being the needs or current interests of the user as defined by the user. The term “health” relates in general to the well-being of the system in part or in whole. Visual health indicators, for example colors green, yellow, red, can alert the user to undertake a diagnosis of all or part of the system which may need attention to maintain the current system status. A visual indicator colored green for example indicates the system or component is healthy and a status factor might reveal it's 30% through playback of feature X. If on the other hand the visual indicator is yellow, or red, the system is unhealthy and may need attention or even immediate repair to maintain a desired status. The term “operational status” is generally understood to include both the health and status factors of the system.

System configuration information includes or may include such information as the types and capabilities of the elements comprising the system 10, identifications of each of those elements, the configuration or arrangement of those elements in the system 10 and is defined independently of actual system operation. Examples of configuration status for a process node 12A could include the types of elements comprising each process node 12A and the functions, capabilities, arrangement or interconnections of each of those elements in each process node 12A.

System operational status could in turn include, for example, the basic operational states of each of the elements identified in the configuration status, such as “available/unavailable”, “on/off”, “standby mode”, “operating”, and so on, and the functional status i.e. health, of those components, such as “within acceptable ranges”, “marginal” or “trending to failure”, that is, and “inoperable” or “failed”. Operational status of, for example, a multi-venue theater system 10, may further include identifications of image sequences that are now being displayed or have been displayed or are next to be displayed, such as advertisements, movie previews or a feature movie, including sound data status, image sequence start, running and elapsed times and rates, predicted time to movie finish, and so on. Yet other status related elements may include data error rates or occurrences, such as errors in image sequences fed from a remote or local image source, error indicators from the projector system 12A, and so on. Therefore, while configuration information is defined independently of the actual system operation, operational status information reflects the potential and actual state of operation of each of the system components and is provided from the operating system elements.

The configuration information and operational status of a system 10 thereby together define the possible functions and operations of the system, the available capabilities and resources of the system, the operations currently being performed by the elements of the system, and current operating state of the system elements in performing those functions.

Lastly, user factors include, as described above, the current interests and needs of the user in monitoring and controlling the operation of the system. According to the present invention, user factors include system operational status factors that the user should be considering, such as operational status trends toward a system error or failure, as well as system factors that the user wishes or desires to consider in order to monitor and control the system.

As described, a “perspective” of system status is a representation of system operational status arranged and presented according to the relative significance of one or more status factors, such as configuration information, system operation status information and user factors. As will be described in further detail in the following, the arrangement and display of status factors in a perspective view according to their relative significance is accomplished by displaying the status factors of each perspective according to a number of selectable display modes or methods. Possible display modes and methods may include, for example, the selection and arrangement of the system 10 elements in a perspective display such a manner as to enhance visibility of the elements of interest for that perspective, including the relative locations and groupings or clusterings of elements in the display of the perspective. Other display modes and methods will typically also include whether or not an element is displayed, the relative shape, size, color and dynamic display properties of each element or arrangement of elements, such as blinking or moving representations, audio alerts and so on.

Therefore now considering the method, system and apparatus of the present invention and again referring to the multi-venue theater management system 10 shown in FIGS. 1, 2 and 3 as an exemplary embodiment of the invention, the node controller 16 of each process node 12A monitors and stores operational status information 24A of the elements comprising the process node 12A. Operational status information 24A may then, for example, be stored in node controller 16 and periodically transmitted through the network 12C connection to system management node 12C, or may be transmitted to system management node 12C upon command or need as determined by either the node controller 16 or system management node 12C.

As described, the monitored elements of a process node 12 typically include at least projection systems 14A, image streams 14B, image source devices 14C, if any, network interface 18, network 12C, and so on, and each item of operational status information 24A will typically also include an identification of the source element of the information item. In addition, status information 24A of a process node 12A may take the form of raw data, that is and for example, numeric values or flags read directly from the monitored elements, or may comprise processed status information, wherein the raw data has been evaluated by node controller 16 according to operational status criteria 26A stored in the node controller 16.

Referring next to the central system management node 12B, system controller 20 will store operational status information 24A received from each process node 12A, and will typically collect and store at least some management node status information 24B pertaining to the operations of central system management node 12B. Status information 24B may include, for example, information pertaining to image streams 14B from, for example, remote image sources 14E or local image sources 14D, and the communications with process nodes 12A through network 12C. It should be noted that system controller 20 may also contain operational status criteria 26B for evaluation of raw operational status information 24A read from process nodes 12A if process node operational status information 24A is provided in raw form rather than evaluated in the process nodes 12A.

System configuration information 28 also resides in system controller 20 and may, for example, be semi-permanently stored therein, downloaded at system start-up, or obtained directly from the process node 12A and system management node 12B elements, either periodically or at system start-up. As described above, system configuration information 28 may include, for example, identifications of each of the elements comprising the system 10 and information identifying the types and capabilities of each element, and the configuration or arrangement of the elements in system 10.

Lastly, user factors 30, which represent the current interests and needs of the user in monitoring and controlling the operation of the system, are entered by the user during system operation through display unit 20G and control input 20H of system management node 12B.

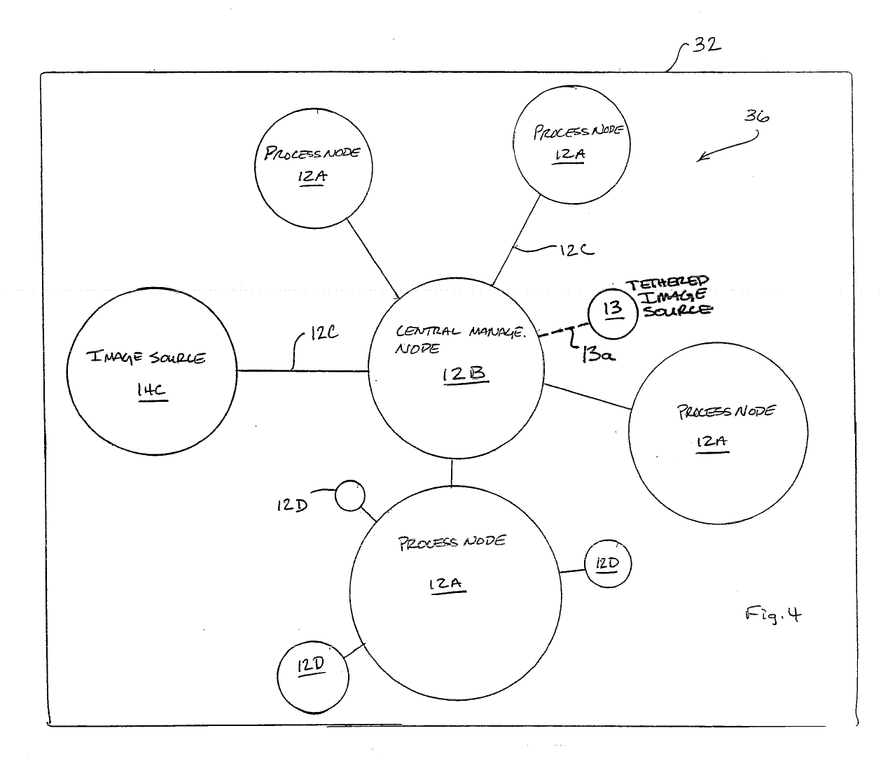

In FIG. 4 is a system status display 32 comprising a visual, graphical representation of one or more perspectives 34 of the current system operational status is generated by system controller 20 from configuration information 28, process node operational status information 24A, management node operational status information 24B and user factors 30 according to a perspective model 36 stored in system controller 20.

A perspective model 36 is selected, for each system 10, to provide a readily comprehensible and unambiguous image of the system 10 to the user. In the present system 10, for example and as illustrated in FIG. 4, perspective model 36 may be comprised of a solar-system-like model comprised of a central “sun” representing central management node 12B surrounded by a plurality of “planets” representing process nodes 12A and image sources 14C. The planets may also include “moons” which could disclose further detail information regarding elements or aspects of the planets, that is, of system management node 12B or process nodes 12A, and the moons may, in turn, be surrounded by further “moons” representing further elements and aspects of the elements and aspects represented by the parent moons. As also described herein above, the communications pathways of network 12C interconnecting system management node 12B and process nodes 12A and other elements of the system 10 may be represented by pathway lines wherein, in a presently preferred embodiment, the network pathway lines are displayed in the perspective model 36 when there is an actual information or data flow through a network 12C pathway, so that the pathway representations thereby represent currently active information or data flows.

Perspective model 36 is a generalized representation of the system 10, but arranged in a manner so as to accommodate variations in or modifications to the model 36 based on the actually operating system 10. In other words the model 36 is a template which can be varied in desired ways to produce the desired perspectives 34. For this reason, the basic perspective model 36 is modified according to system configuration information 28 to correspond to the actually existing system 10. Such modifications may adapt the basic display model 36 according to, example, the actual current number and types of process nodes 12A or system management nodes 12B or to accommodate differences among internal configurations of the process nodes 12A or the configuration of network 12C or types and capacities of the pathways comprising network 12C, such as high speed serial connections or cable connections.

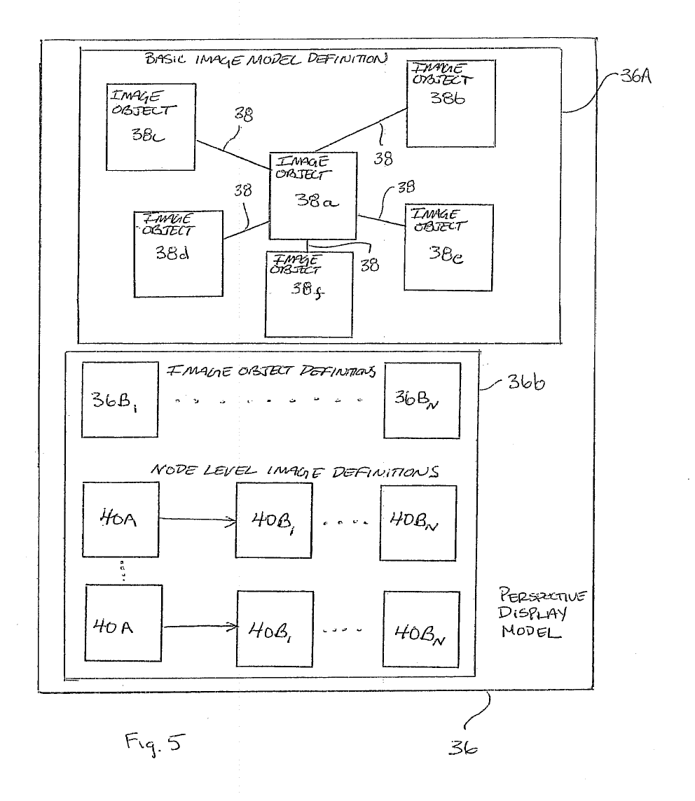

An exemplary data structure for the perspective model 36 as illustrated in FIG. 5 may therefore include a basic image model definition 36A representing a general embodiment of the system 10 as a plurality of image objects 38a-38f arranged to represent the system 10. In the present example of a system 10, the basic image model definition 36A may define the system 10 as comprising a central image object 38a of a first type surrounded by a plurality image objects 38b-38f of a second type and possibly one or more image objects 38 of a third type, all interconnected by image objects 38 representing network 12C.

Perspective model 36 will also include a plurality of basic image object definitions 36B wherein each image object definition 36B_{1-N} corresponds to one of image objects 38. Each image object definition 36B_{1-N} defines, for example, the basic location, shape, size, beginning and end points and other graphical characteristics, such as color, line style and width, and so on, of the corresponding image object 38.

It is recognized that many perspectives 34 of a system 10 require the display of configuration and operational status information at lower levels of detail than are presented by basic image model definition 36A and image object definitions 36B. For example, certain perspectives 34 may require representation of the internal configuration and operational status of the elements within a process node 12A or system management node 12B. For this reason, perspective model 36 will include a node level image model definition 40A for and corresponding to each type of node 12 in the system 10 and, for each node image model definition, a plurality of image object definitions 40B_{1-N} defining the graphical characteristics of each element in the corresponding node 12.

It will be recognized that the perspective model 36 of a given system 10 may include still lower hierarchical levels of detail if required by the perspectives 34 that it may be necessary to generate to satisfactorily represent the operational status of a given system 10.

It will also be recognized that the representations of the elements of a system 10 or node 12A or 12B in a given system 10 are not limited to purely graphical elements, but may also include alphanumeric information and data, such as parameters representing the operational status or condition of a particular element or operation of interest in the system 10. In such cases, the actual alphanumeric information appearing in a representation of the system 10 or a node 12 thereof may be read from the actual or processed operational status information 24A or 24B stored in system controller 20.

In summary, therefore, the system level basic image model definition 36A and image object definitions 36B, the node level image model definitions 40A and image object definitions 40B and progressively lower levels of perspective model 36 definitions define the visual elements and aspects of the basic graphical representation of the system 10 according to configuration information 28 at all required levels of detail.

Returning to FIG. 3 the graphical image information residing in basic image model definition 36A, image object definitions 36B, node level image model definitions 40A and image object definitions 40B, and so on, residing in system controller 20 is read to graphical display processor 20I by system controller 20. Graphical display processor 20I generates the corresponding images of a system status display 32 and the system status display 32 is then displayed through display unit 20G of system management node 12B. It should be noted that in present implementations of the invention, graphical display processor 20I may be, for example, a separate processor unit dedicated to this task or implemented in system processor unit 20A under control of graphic generation programs 20J residing in processor controller 20.

A system status display 32 generated solely from system configuration information 28, that is, solely from basic image model definition 36A, image object definitions 36B, and so on, will comprise a single perspective 34 representing the inherent or potential operational status of the system 10, that is, the quiescent status of the system, rather than the actual operational status of the system 10. A perspective 34 or perspectives 34 representing the operational status of a system 10 during operation of the system 10, however, is generated by modification of the status display 32 graphic elements generated from basic image model definition 36A, image object definitions 36B, and so on, in accordance with process and system management node operational status information 24A and 24B and user factors 30. As discussed above, these modifications to the graphic elements of the basic status display 32 may include, for example, altering the relative locations and groupings or clusterings of elements in the display of the perspective, whether or not an element is displayed, the relative shape, size, color and dynamic display properties of each element or arrangement of elements, such as blinking or moving representations, and so on.

To illustrate, the basic status display 32 of the system 10 in the quiescent operating state, that is, as defined by system configuration information 28, may appear as shown in FIG. 4 and represents a generalized, basic perspective 34 view of the system 10 and the operational status of system 10. The basic status display 32, however, will be modified to display different or further perspectives 34 upon, for example, a user's entry of one of more user factors 30 indicating the desires of the user with regard to viewing the operational status and health of the system 10 or a change in the operation of the system 10 desired by the user. The status display 32 may also be modified upon the occurrence of certain system 10 events, such as a change in the system operating status or health or the addition of at least a tethered image source, mass storage device or hard drive 13 which can be temporarily connected with the central management node 12B for example via USB connection 13a.

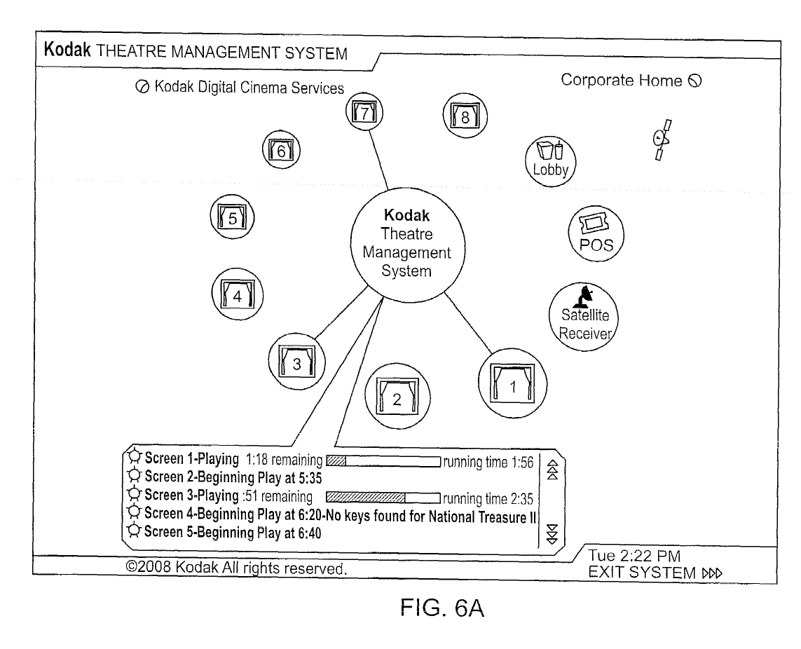

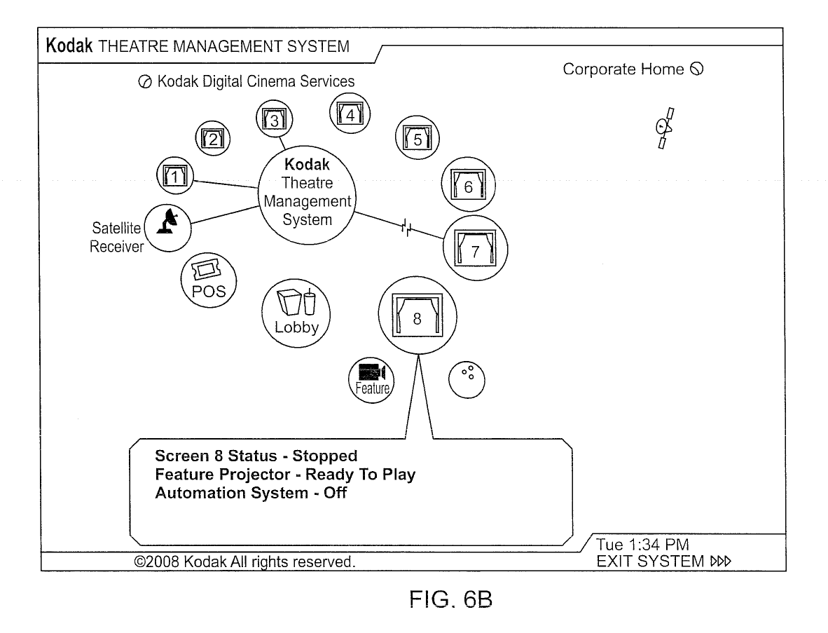

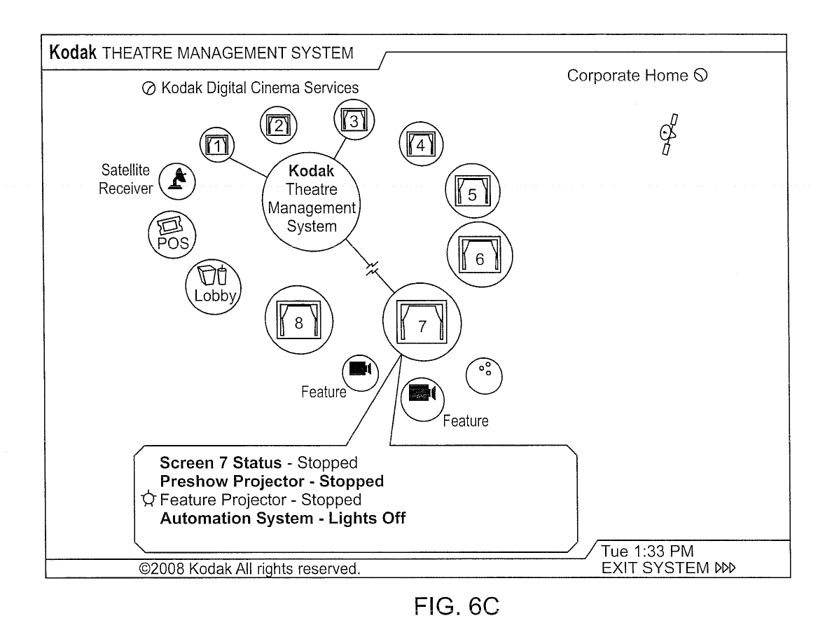

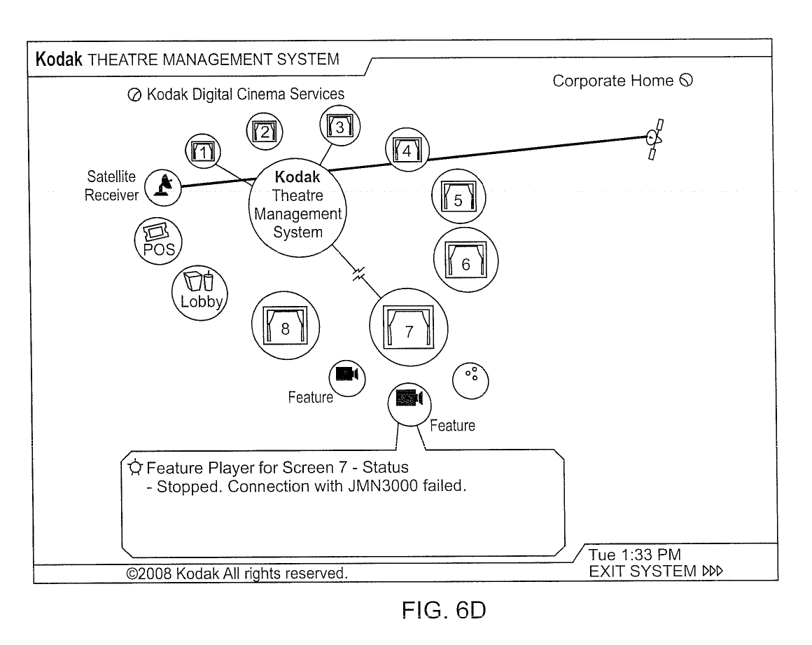

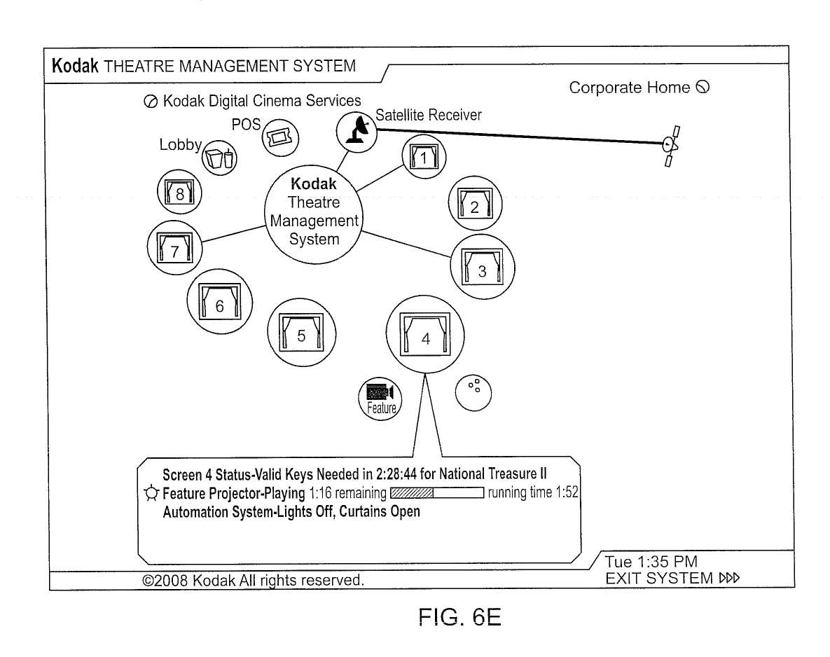

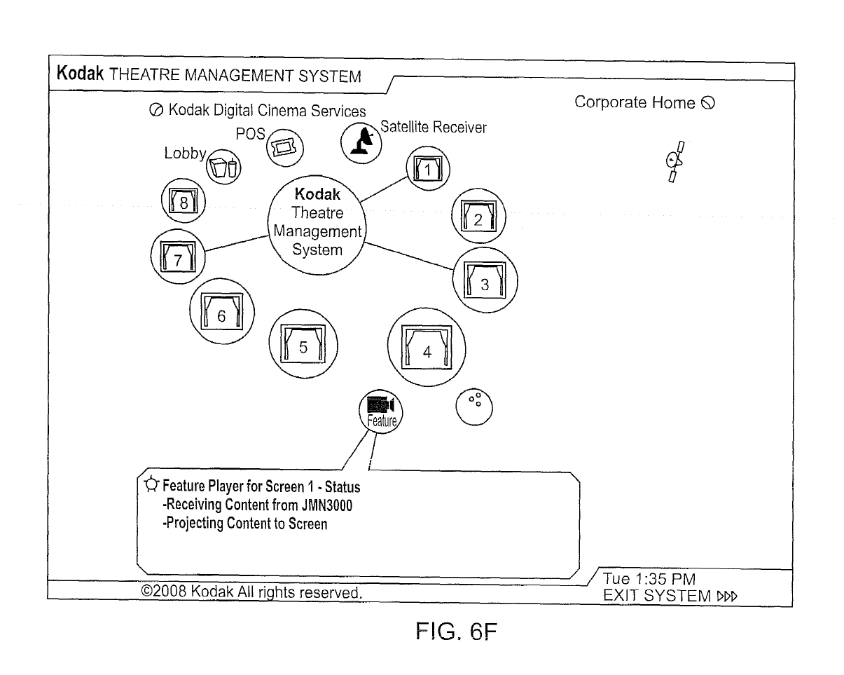

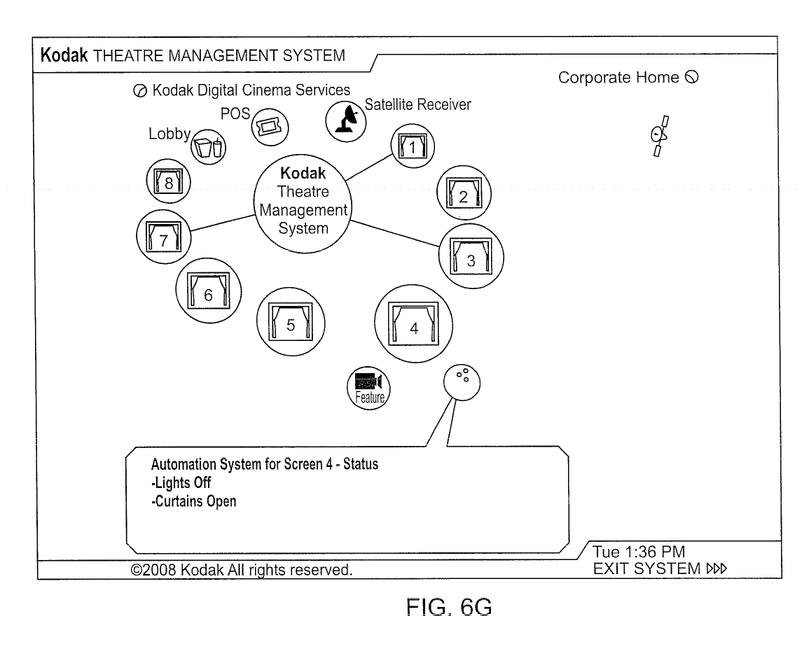

Exemplary modifications of status display 32 to present differing perspectives 34 to the user are illustrated in FIGS. 6A-6G. For example, the user may enter one or more user factors 30 indicating a desire to view the detailed operational status of a certain process node 12A, resulting in the display of a corresponding perspective 34a in the system status display 32. This perspective 34a may be represented, for example, by changes in the size and color of the object image 38 of that process node 12A as illustrated in FIG. 6. The object image 38 representing the process node 12A may also be replaced with a more detailed object image 38, based on an image object definitions 36B, to show the interior elements and operational status of the process node 12A. The graphic modifications to status display 32 to accommodate the perspective 34a may further include altering the relative positions of the object images of the remaining process nodes 12A and management node 12B to further visually emphasize the selected process node 12A, as well as to provide space for the expanded representation of the process node 12A.

The next perspective 34 related event may be the detection of a change in the operational status of a second process node 12A potentially requiring the attention of the user, typically a system operator, thereby requiring the addition of a second perspective 34b to the system status display 32. This event will be represented by a change the corresponding process node operational status information 24A residing in system controller 20. System controller 20 will detect this change and direct graphical display processor 20I in generating a second, corresponding perspective 34b in a manner determined by the relative significance of the change in operational status, which may also result in corresponding alterations in the first perspective 34a. For example, the status change may not be of a critical or emergency nature, in which case the procedure would be to bring the change to the user's attention in an unmistakable manner while not interrupting the graphical representation of the first perspective 34a, thus avoiding a potentially disorienting change in the status display 32. In this case, the user may be alerted to the status change by a change in, for example, the size or color of the object image 38 corresponding to the second process node 12A or the imposition of a “blinking” effect or a combination of visual enhancements.

A more critical status change, however, or a user factor 30 input indicating that the user wishes to view the second process node 12A in detail, may result in a change in the location and level of detail with which the second process node 12A is represented. That is, the second perspective 34b may represent the second process node 12A in the same manner as the first process node 12A with corresponding alterations in the relative positions of the remaining node representations in the status display 32. In this case, however, the first perspective 34a representation of the first node 12A may be reduced in emphases, such as by reducing the size or level of detail with which the node is represented, but retaining some level of visual enhancement to remind the user of his previous focus or task.

The modification of the basic system status display 32 generated from basic system configuration information 38 and the basic image model definition 36A, image object definitions 36B, and so on, to reflect process node and system management node operational status information 24A and 24B and user factors 30 is accomplished by prioritized modification of the graphic objects 38 comprising that basic status display 32. For this purpose, system controller 20 includes a graphic modification library 42 storing indexed image modification sets 44 for and corresponding to the basic perspective model 36 and each type of node 12 or image object 38 appearing in a status display 32.

Each image modification set 44 is indexed according to the status display 32 graphic object or objects to which it applies or may be applied, such as model 36 or a given type or types of node 12 or image object 38, and according to each status state in which it is applied wherein a status state is a combination of process node and management node operational status information 24A and 24B values and user factors 30. Each image modification set 44 includes one or more visual characteristics that are selected to be appropriately applicable to the graphic object or objects to which it may be applied under the status conditions in which the characteristics are to be applied, as described in the above examples of the generation of perspectives 34 for various status conditions. The visual characteristics included in one or more image modification sets may include, for example, the relative locations, groupings or clusterings of image objects, whether or not an element or object is displayed, the relative shape, size, color and dynamic display properties of each element or arrangement of elements, such as blinking or moving representations, and so on.

System controller 20 controls the generation of perspectives 34 of status display 32 by monitoring process node operational status information 24A, management node operational status information 24B and user factors 30 to detect changes in any of status information 24A or 24B or a user factor 30. Upon detecting a change in any of status information 24A or 24B or a user factor 30, system controller 20 indexes image modification sets 44 of graphic modification library 42 to determine the corresponding changes in perspectives 34 and status display 32, and provides the selected modification set or sets 44 to graphical display processor 20I, which generates the corresponding perspective 34 or perspectives 34 comprising status display 32.

A status display 32 of one or more perspectives 34 according to the present invention is not constrained solely to the passive display of status information, but may also be implemented as an active control input mechanism by constructing selected image objects 38 of display model image 36 and perspectives 34 as “active” elements in the manner well known in graphic user interfaces. In such implementations, the above described capabilities of a status display 32 according to the present invention, and in particular the use of user factor 30 inputs by a user through control input 20H of management node 12B, may be employed to access such “active” image objects 38 at any desired level of detail in the perspective 34 representations of process nodes 12A, management node 12B or network 12C. For example, a user may provide a user factor 30 input indicting a desire to view a particular process node 12A in greater detail, upon which the system will modify status display 32 by enlarging the visual depiction of that process node 12A and displaying further detail of the internal configuration and status of the elements therein. The image objects 38 comprising the more detailed view of that process node 12A will include “active” image objects 38, or “active” regions of image objects 38, through which the user can then enter new commands or data by means of a keyboard or mouse of control input 20H.

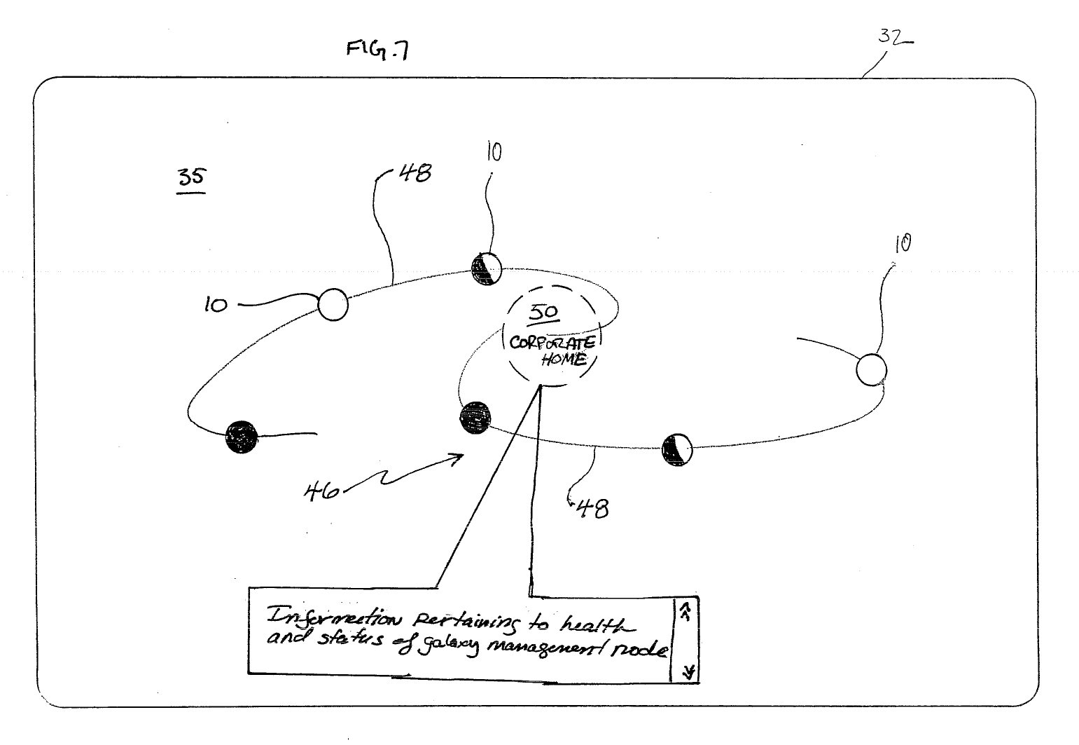

Lastly, observing FIG. 7 the status display 32 may include a higher level galaxy perspective 35 according to the present invention where each system 10 (or solar system) as shown and described in FIGS. 1-6, is part of a galaxy system 46 including a plurality of the solar systems 10. The galaxy system 46 is defined by a plurality of trailing regions 48 extending from a common center of mass. Each region contains zero to any number of representative elements of the solar systems 10 therein. The solar systems 10 in any single region may be related by any desired characteristics for example by geographical location or a particular similar number of planets in each solar system 10.

Each solar system 10 displayed in the galaxy system 46 may be reduced to a desired graphical representation of the respective system 10, for instance a single planetary object which may be solely associated with the trailing region 48 in which it resides. Alternatively, a galaxy management node 50 may be provided at or about the center of mass of the galaxy system 46 to facilitate a higher level omniscient management of the galaxy system and the individual solar systems 10. Thus, the galaxy system 46 can include levels of detail where required to represent the operational status of the given galaxy system 46 via the galaxy management node 46, as well as the operational status of the individual solar systems 10. Such detail may include a feature where the representative element of a solar system 10 in the galaxy system 46 is accorded a prioritized operational visual indicator based on node level information in the solar system 10 itself. More specifically, and by way of example this could be where the solar system representative element displayed as a single node in the galaxy system 46 inherits the color or other visual indicator of the weakest performing node level element in the solar system 10 to provide the user with a high level view with alert indicators for lower level functions. Different visual indicators as seen in the different solar systems 10 of FIG. 7 may communicate specific or general information relevant to the operation and/or health of the solar system 10.

It will also be recognized that the representations of the solar system 10 elements in a given galaxy system 40 are not limited to purely graphical elements, but may also include alphanumeric information and data, such as parameters, communication and connectivity, representing the operational status or condition of a particular system 10 or element or operation of interest in the system 10. In such cases, the actual alphanumeric information appearing in a representation of the system 10 or a node 12 thereof may be read from the actual or processed operational status information 24A or 24B stored in system controller 20. Additionally, data migration through the system, for example from the system management node 12B to a process noted 12A and vice versa, can be shown via visual representation of such migration between such elements so that a real time data transfer and acquisition by the system can be monitored by the user.

Although not discussed in detail, it is also to be appreciated that even higher level views and display representations are possible for example universe views including visual representations of numerous galaxies. Conversely, lower level views where the user can drill into individual components and sub-systems of the management and process nodes of the system are also clearly within the scope of the invention.

Since certain changes may be made in the above described method and system without departing from the spirit and scope of the invention herein involved, it is intended that all of the subject matter of the above description or shown in the accompanying drawings shall be interpreted merely as examples illustrating the inventive concept herein and shall not be construed as limiting the invention.

PARTS LIST

| | |
|---|---|
| 10 | system |
| 12A | process node |
| 12B | system management node |
| 12C | network |
| 12D | process node details |
| 14A | projection system |
| 14B | digital image stream |
| 14C | image source device |
| 14D | storage devices |
| 14E | remote image sources |
| 16 | node controller |
| 16A | node processor unit |
| 16B | memory |
| 16C | node control and monitoring programs |
| 16D | mass storage devices |
| 16E | monitoring connections |
| 16F | environmental sensors |
| 16G | display unit |
| 16H | control input |
| 18 | node network interface |
| 20 | system controller |
| 20A | system processor unit |
| 20B | memory |
| 20C | system control and monitoring programs |
| 20D | mass storage devices |
| 20E | monitoring connections |
| 20F | environmental sensors |
| 20G | display unit |
| 20H | control input |
| 20I | graphical display processor |
| 20J | graphical generation programs |
| 22 | network interface |
| 24A | process node operational status information |
| 24B | management node operational status information |
| 26A | process node operational status criteria |
| 26B | management node operational status criteria |
| 28 | system configuration information |
| 30 | user factors |
| 32 | system status display |
| 34 | perspective |
| 35 | galaxy perspective |
| 36 | perspective model |
| 36A | basic image model 36A |
| 36B | image object definition |
| 38 | image object |
| 40A | image model definition |
| 40B | image object definition |
| 42 | graphic modification library |
| 44 | image modification set |
| 46 | galaxy system |
| 48 | trailing region |
| 50 | galaxy management node (corporate home) |

1. A method for displaying operational status of an information processing system including a plurality of process nodes, a system management node for controlling the plurality of process nodes and a network interconnecting the process nodes and the system management node, comprising the steps of:
generating a perspective display mode image including a plurality of processing node images, a system management node image and a network image depicted and arranged according to a system configuration,
generating a system status display image by modifying the perspective display model image to represent a perspective of the operational status of the system wherein a perspective of an operational status of the system is a visual representation of the system according to a relative significance of at least one aspect of the operational status of the system, and
displaying the system status display image containing the perspective of the operational status of the system.

2. The method of claim 1 for displaying operational status of an information processing system, wherein:
the at least one aspect of the operational status of the system includes at least one of
system configuration information,
system operational status information, and
a user factor representing a display preference of a user of the system status display.

3. The method of claim 1 for displaying operational status of an information processing system, further comprising the steps of:
detecting at least one of a change in an operational status in at least one of the processing and system management nodes and the network and a user factor input indicating a display preference of a user of the system status display,
generating a new system status display image by modifying the perspective model to represent at least one second perspective representing the at least one of a change in an operational status of at least one of the processing and system management nodes and the network and a user factor input, and
displaying the new system status display image.

4. The method of claim 1 for displaying operational status of an information processing system, wherein:
the system status display image contains a plurality of perspectives depicted and arranged to represent a relative priority of visual display between the perspectives.

5. The method of claim 1 for displaying operational status of an information processing system, wherein:
the perspective model is a sun and planet solar system model wherein a system management node image occupies a central sun position and each process node is represented by a process node image occupying a planet position around the sun position and wherein the network has a hub and spoke configuration represented by pathway lines connecting the system management node image with each process node image.

6. The method of claim 5 for displaying operational status of an information processing system, wherein:
system elements within a process node are displayable as element object nodes occupying moon positions around the planet position occupied by the process node.

7. The method of claim 5 for displaying operational status of an information processing system wherein the first perspective comprises a representation of an operational status of at least one of the system management node, a process node and the network, further comprising the steps of:
generating a new system status display image containing the first perspective and a second perspective wherein the first and second perspectives are depicted and arranged to represent a relative priority of visual display between the first and second perspectives, wherein
the relative priority of visual display between perspectives is represented by at least one of
relative size,
color,
animation,
relative location, and
relative level of detail in depiction of the perspectives.

8. The method of claim 1 for displaying operational status of an information processing system, wherein:
a perspective is represented by at least one image object displayable in the system status display and the at least one image object includes an active image object for control input to the system.

9. The method of claim 3 for displaying operational status of an information processing system, further comprising the steps of:
detecting a transfer of data through the network and between nodes of the system,
generating a new system status display image by modifying the perspective model to include a visual representation of the transfer of data between nodes of the system, and
displaying the new system status display image.

10. The method of claim 1 for displaying operational status of an information processing system, wherein:
the information processing system is a multi-venue theater management system, wherein
each process node includes
at least one of a theater function, theater component and image projection system for displaying image streams from an image source, and
a process node controller responsive to the system manager node for monitoring and controlling the at least one the theater function, theatre component and image projection system.

11. The method of claim 10 for displaying operational status of an information processing system, wherein the process node includes the image projection system and the image source is at least one of
an image source located in the process node,
an image source located in the system management node, and
a remote image source located externally to the system.

12. A system for displaying operational status of an information processing system including a plurality of process nodes, a system management node for controlling the plurality of process nodes and a network interconnecting the process nodes and the system management node, comprising:
a perspective display generator for generating a perspective display mode image including a plurality of processing node images, a system management node image and a network image depicted and arranged according to a system configuration,
a status display generator for generating a system status display image by modifying the perspective display model image to represent a perspective of the operational status of the system wherein a perspective of an operational status of the system is a visual representation of the system according to a relative significance of at least one aspect of the operational status of the system, and
a display system for displaying the system status display image containing the perspective of the operational status of the system.

13. The system of claim 12 for displaying operational status of an information processing system, wherein:
the at least one aspect of the operational status of the system includes at least one of
system configuration information,
system operational status information, and
a user factor representing a display preference of a user of the system status display.

14. The system of claim 12 for displaying operational status of an information processing system, wherein:
the status display generator is responsive to at least one of a change in an operational status in at least one of the processing and system management nodes and the network and a user factor input indicating a display preference of a user of the system status display for
generating a new system status display image by modifying the perspective model to represent at least one second perspective representing the at least one of a change in an operational status of at least one of the processing and system management nodes and the network and a user factor input, and
the display generator is response to the new system status display image for displaying the new system status display image.

15. The system of claim 12 for displaying operational status of an information processing system, wherein:
the system status display image contains a plurality of perspectives depicted and arranged to represent a relative priority of visual display between the perspectives.

16. The system of claim 12 for displaying operational status of an information processing system, wherein:
the perspective model is a sun and planet solar system model wherein a system management node image occupies a central sun position and each process node is represented by a process node image occupying a planet position around the sun position and wherein the network has a hub and spoke configuration represented by pathway lines connecting the system management node image with each process node image.

17. The system of claim 16 for displaying operational status of an information processing system, wherein:
system elements within a process node are displayable as element object nodes occupying moon positions around the planet position occupied by the process node.

18. The system of claim 16 for displaying operational status of an information processing system wherein the first perspective comprises a representation of an operational status of at least one of the system management node, a process node and the network, wherein:
the status display generator is responsive to at least one of a change in an operational status in at least one of the processing and system management nodes and the network and a user factor input indicating a display preference of a user of the system status display for
generating a new system status display image containing the first perspective and a second perspective wherein the first and second perspectives are depicted and arranged to represent a relative priority of visual display between the first and second perspectives, wherein
the relative priority of visual display between perspectives is represented by at least one of
relative size,
color,
animation,
relative location, and
relative level of detail in depiction of the perspectives.

19. The system of claim 12 for displaying operational status of an information processing system, wherein:
a perspective is represented by at least one image object displayable in the system status display and the at least one image object includes an active image object for control input to the system.

20. The system of claim 14 for displaying operational status of an information processing system, wherein:
the status display generator is responsive to a transfer of data through the network and between nodes of the system, for
generating a new system status display image by modifying the perspective model to include a visual representation of the transfer of data between nodes of the system, and
the display system is responsive to the new system status display image for displaying the new system status display image.

21. The system of claim 12 for displaying operational status of an information processing system, wherein:
the information processing system is a multi-venue theater management system, wherein
each process node includes
at least one of a theater function, theater component and an image projection system for displaying image streams from an image source, and
a process node controller responsive to the system manager node for monitoring and controlling the at least one of the theater function, theater component and image projection system.

22. The system of claim 21 for displaying operational status of an information processing system wherein the process node includes the image projection system and the image source is at least one of
an image source located in the process node,
an image source located in the system management node, and
a remote image source located externally to the system.
